(19) United States
(12) Patent Application Publication
(10) Pub. No.: US 2014/0175248 A1
(43) Pub. Date: Jun. 26, 2014

(54) ADJUSTABLE SUPPORT DEVICE

(71) Applicants: HON HAI PRECISION INDUSTRY CO., LTD., New Taipei (TW); Fu Tai Hua Industry (Shenzhen) Co., Ltd., Shenzhen (CN)

(72) Inventors: GANG-TAO FAN, Shenzhen (CN); MU-GEN YUAN, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/014,422

(22) Filed: Aug. 30, 2013

(30) Foreign Application Priority Data
Dec. 26, 2012 (CN) 2012105710987

(51) Int. Cl. F16M 11/20

(52) U.S. Cl. CPC F16M 11/2021
USPC 248/346.01

(57) ABSTRACT

A support device for adjusting the orientation of a robotic arm or other movable object includes a base, and a support plate defining two threaded holes. A connecting member has a first end connected to the support plate, and a second end which is connected to the base as a universal pivot. Two screws each include a threaded shank, and the two screws provide adjustable respective distances between the support plate and the base by engagement of the threaded shanks and the threaded holes. An elastic member applies a pulling force to the support plate, maintaining the contact between the abutting ends of the threaded shanks and the base.

### BACKGROUND

1. Technical Field

The present disclosure relates to support devices, such as those used in automated manufacturing.

2. Description of Related Art

Robotic arms are common in manufacturing industries. The orientation of a robotic arm may need to be adjusted, such that the robotic arm can be used with some parts having a complicated structure. Therefore, there is a need to provide an adjustable support device that supports the robotic arm and can provide the robotic arm with different orientations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is an isometric view of an adjustable support device according to one embodiment.

FIG. 2 is a cross-sectional view of the adjustable support device of FIG. 1, taken along line II-II thereof.

### DETAILED DESCRIPTION

Embodiments of the present disclosure will be described with reference to the accompanying drawings.

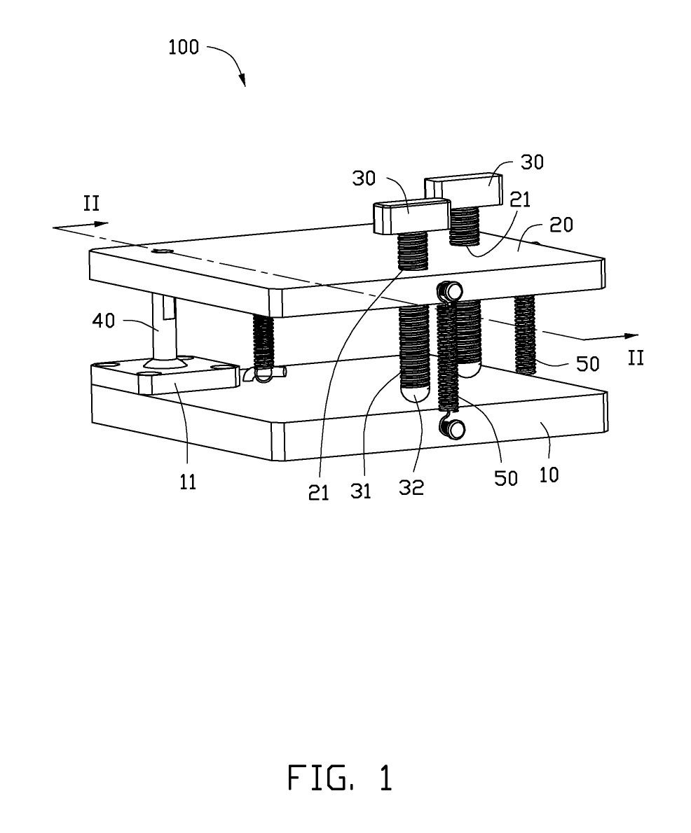

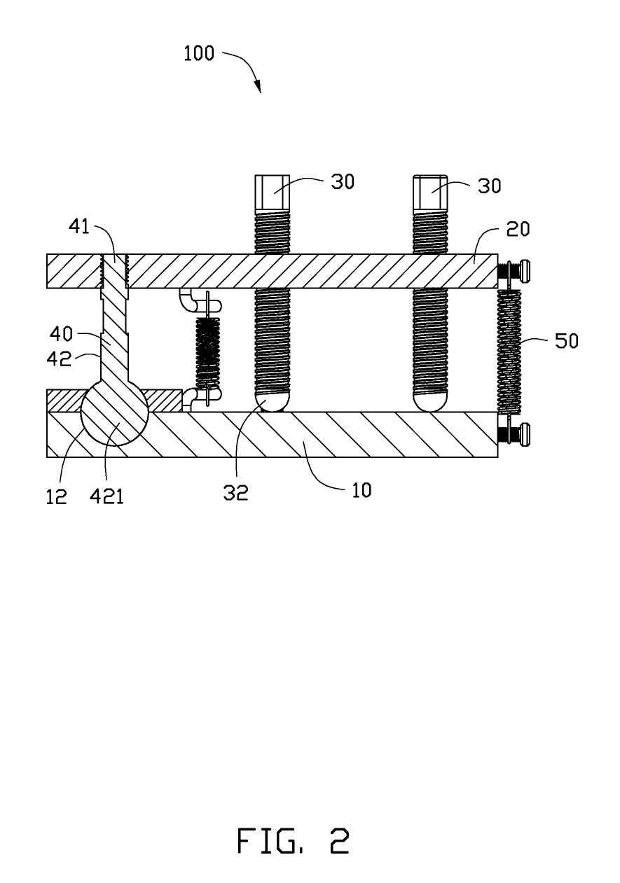

Referring to FIGS. 1-2, an adjustable support device 100 is typically used for adjusting the orientation of a robotic arm or other movable object. The adjustable support device 100 includes a base plate 10, a support plate 20, two screws 30, a connecting member 40, and a resilient member 50. The support plate 20 defining two threaded holes 21. Each screw 30 includes a threaded shank 31 that passes through and engages with one corresponding threaded hole 21.

Each threaded shank includes a free end 32 that abuts against the base plate 10. The free end is not threaded, and is rounded. In the embodiment, each screw 30 further includes a shaped head on the top end of the shank 31. A wrench can be used to grip the heads and turn the screws 30.

The connecting member 40 has a first end 41 securely connected to the support plate 20, and a second end 42 pivotally connected to the base plate 10. In the embodiment, the first end 41 is threadedly connected to the support plate 20. The second end 42 includes a ball head 421. A fixing plate 11 is secured to the top of the base plate 10. The fixing plate 11 and the base plate 10 cooperatively define a socket 12, and the ball head 421 is movably received in the socket 12. In particular, the ball head 421 is unconstrained in rotatability and in angle, in relation to the socket 12. In other embodiments, the first end 41 may be secured to the support plate 20 by other suitable connecting techniques.

The resilient member 50 has opposite ends that are secured to the base plate 10 and the support plate 20. The elastic member 50 pulls on the support plate 20, thereby maintaining the free ends 32 of the threaded shanks 31 in contact with the base plate 10. The support 20 is thus supported by the connecting member 40 and the two screws 30, and is stationary with respect to the base plate 10.

The support plate 20 can support a robotic arm, for example. When the orientation of the robotic arm requires adjustment, a user can turn the screws 30 to change the distance and the angle between the base plate 10 and the support plate 20, until a required orientation of the robotic arm is obtained.

While various embodiments have been described and illustrated, the disclosure is not to be construed as being limited thereto. Various modifications can be made to the embodiments by those skilled in the art without departing from the true spirit and scope of the present disclosure.

What is claimed is:

1. An adjustable support device comprising:
a base;
a support plate defining two threaded holes;
a connecting member comprising a first end securely connected to the support plate, and a second end pivotally connected to the base;
two screws each comprising a threaded shank, the two screws being movably connected to the support plate by interengagement of the threaded shanks and the threaded holes, each threaded shank comprising a free end that abuts against the base; and
an elastic member with opposite ends secured to the base and the support plate, the elastic member being configured to apply a pulling force to the support plate, thereby biasing the free ends of the threaded shanks to stay in contact with the base.

2. The adjustable support device according to claim 1, wherein the elastic member is a coil spring.

3. The adjustable support device according to claim 1, wherein the first end of the connecting member is threadedly connected to the support plate.

4. The adjustable support device according to claim 1, further comprising a fixing plate secured to the base, wherein the second end comprises a ball head, the fixing plate and the base cooperatively define a socket, and the ball head is rotatably fitted in the socket.

5. The adjustable support device according to claim 1, wherein the free end of each threaded shank is rounded.
